(19) United States
(12) Patent Application Publication
(10) Pub. No.: US 2005/0031581 A1
(43) Pub. Date: Feb. 10, 2005

(54) Termite feeding stimulant and method for using same

(76) Inventors: David M. James, Fort Collins, CO (US); Elisa J. Bernklau, Bellvue, CO (US); Matthew Siderhurst, Sutherland (AT); Erich A. Fromm, Greeley, CO (US); Robert Jason Bishop, Windsor, CO (US); Louis B. Bjostad, Bellvue, CO (US)

Correspondence Address: SHERIDAN ROSS PC, 1560 BROADWAY, SUITE 1200, DENVER, CO, 80202, US

(21) Appl. No.: 10/840,869

(22) Filed: May 7, 2004

Related U.S. Application Data
(63) Continuation-in-part of application No. PCT/US02/35975, filed on Nov. 8, 2002.
(60) Provisional application No. 60/347,988, filed on Nov. 8, 2001.

(51) Int. Cl. A01N 25/00; A01N 25/08

(52) U.S. Cl. 424/84; 424/410

(57) ABSTRACT

A termite feeding stimulant and a method for using the same including a sitosterol containing formulation useful for increasing feeding or inducing phagostimulatory responses by termites, and in particular the following species of termites: Coptotermes formosanus, Reticulitermes tibialis, Reticulitermes flavipes, and Reticulitermes virginicus.

### CROSS REFERENCE TO RELATED APPLICATIONS

The present application is a continuation-in-part of International Application No. PCT/US02/35975, filed Nov. 8, 2002, and which designated the U.S., which in turn claims the benefit of U.S. Provisional Patent Application No. 60/347,988 filed Nov. 8, 2001.

### FIELD OF THE INVENTION

The present invention is directed to a termite feeding stimulant and a method for using the same, and more particularly, is directed to sitosterol containing formulations which are useful for increasing feeding or inducing phagostimulatory responses by all termite species. Termite species known to show increased feeding on cellulosic baits containing sitosterol include Coptotermes formosanus, Reticulitermes tibialis, Reticulitermes flavipes, and Reticulitermes virginicus. The present invention is also applicable to other important pest species of termites, in particular: Reticulitermes hesperus, Reticulitermes hageni, and Heterotermes species.

### BACKGROUND OF THE INVENTION

The damage caused by various insects, and in particular, wood boring and eating inspects, such as termites, is extensive around the world, totaling in the billions of dollars. Various methods and devices have been used in the past in an attempt to alleviate or at least ameliorate the significant destruction caused by such insects. For example, so called “bait stations” have been utilized in an attempt to attract termites and thereby trap and/or destroy the termites that enter into such bait stations. Bait stations are available in a variety of shapes, sizes and structures, but principally rely upon the attractiveness of a cellulose product, such as paper or wood, to attract termite populations. It is believed that the termites are attracted to the cellulose wood product as a food source, however, prior art investigators have never conclusively determined what particular aspect of the cellulose product used in such bait stations actually is the attractive agent. Such cellulose products are typically treated with a toxin so that when the termites consume the treated cellulose products, such termites are incapacitated and/or killed. A significant problem in termite control, however, is the rejection of baits by termites.

There is presently a long felt but unsolved need for a method and device that overcomes bait rejection by termites, overcomes desertion of bait stations, and causes termites to increase their consumption of baits that contain insecticides, in a fashion superior to prior art methods and devices.

The damages caused by such insects is estimated to be over one billion dollars in the U.S. alone. Although pesticides have been used in the past to remedy such problems, they have been largely ineffective and have proven to cause environmental problems and to be fairly expensive.

### SUMMARY OF THE INVENTION

One aspect of the present invention is directed to behavioral manipulation of termites, and in particular, four particular species of termites, i.e., Coptotermes formosanus, Reticulitermes tibialis, Reticulitermes flavipes, Reticulitermes virginicus, Reticulitermes hesperus, Reticulitermes hageni, and Heterotermes species, using sitosterol or sitosterol mimics thereof to increase the feeding of such insects. In particular, the present invention is directed to increasing feeding activities of termites of at least the above-identified four species to a site having sitosterol or sitosterol mimics. More particularly, the use of sitosterol or sitosterol mimics for increasing feeding or inducing phagostimulatory responses: (i) on termite baits, and/or (ii) on substances useful in detecting the presence of such termites is also encompassed by the scope of the present invention. In addition to sitosterol, the present invention also encompasses the inclusion of other co-feeding stimulants, and further includes the inclusion of various toxic compounds, as well as compounds that interfere with the sexual reproduction of such insects.

In one particular embodiment of the present invention, sitosterol compounds are used in combination with one or more of: D-aspartic acid, L-glutamic acid, hydroquinone (as well as other termite labial gland secretions) and ergosterol-containing compounds.

One advantage of the present invention is that the use of sitosterol, without short acting toxic compounds, avoids problems encountered in the prior art where termites are killed by a toxic agent before such termites spread a toxicant throughout the termite colony, thus leading to a decrease in termite baiting efficacy. Other problems in the prior art that the present invention addresses relate to termite eating deterrent effects that are evidenced when particular bait materials have pesticides added to such bait materials.

The present invention encompasses the use of any chemical source of sitosterol at various concentrations in order to increase and/or otherwise manipulate the feeding habits of termites, and in particular, termites from the above-identified four species. Moreover, any biological source of sitosterol, at any effective concentration, to increase or manipulate such feeding is also within the scope of the present invention. For example, bacteria, yeast, etc. that produce sitosterol, particularly genetically engineered microorganisms, can be used in the present invention. Finally, chemical mimics of sitosterol (which one of ordinary skill in the art will appreciate how to make and use given the guidance provided in the present specification as well as that provided in the prior art incorporated herein by this reference) can also be used at a wide range of effective concentrations to increase or manipulate the feeding of the above-referenced termite species.

Thus, in one embodiment, sitosterol containing compounds or formulations are used without any other compounds which may have significant toxic effects on termites. Moreover, although sitosterol is a hydrophobic compound which resists being washed off by soil moisture, a further aspect of the present invention relates to providing such sitosterol containing compounds or formulations with features of increased hydrophobicity, encapsulation, mixture with adhesive compounds, etc. In particular, increasing such features facilitates effective placement or retention of such sitosterol containing compounds or sitosterol formulations to achieve the desired goal of attracting and increasing the feeding of at least the particular termite species identified-above.

The present invention is directed to any particular concentrations of sitosterol that can be used in a given formulation (e.g., from about 0.01% (by weight), more preferably at least about 0.1% and even more preferably, at least about 1%), and in various different applications. In particular, such applications may utilize sitosterol for increasing termite feeding in a concentration of at or about 5% (by weight), although even greater concentrations are also contemplated.

It is a further aspect of the present invention to provide a formulation including sitosterol and one or more substances toxic to termites, wherein such substances include one or more of: noviflumuron, sulfluramid, hydramethylnon, diflubenzuron, fipronil, imidacloprid, boric acid, cypermethrin, permethrin, bifenthrin, esfenvalerate, deltamethrin, cyfluthrin, silica gel, propoxur, hexaflumuron, a chitin synthesis inhibitor, a substance that prevents molting, lufenuron, thiamethoxam, a pesticide from the neo-nicotinoid family of pesticides.

Still further aspects of the present invention relate to the use of sitosterol formulations in the construction and use of termite bait traps and other typical termite controlling and regulating devices.

Other features and benefits of the present invention will become evident from the accompanying figures and the Detailed Description hereinbelow.

### BRIEF DESCRIPTION OF THE DRAWINGS

FIG. 1 is a bar graph for a field study that illustrates the average amount eaten in grams of a control cellulose pellet as compared to a cellulose pellet containing 1% sitosterol for 15 test samples (i.e., n=15). Note that the “I” notation at the top of the bars in this figure, and subsequent figures, represents the range of a standard error as one skilled in the art will understand.

FIG. 2 is a bar graph that compares: (i) the results of Reticulitermes tibialis feeding on a “control” cellulose feeding square provided on a thin-layer chromatography (TLC) glass plate, wherein no sitosterol was provided to the control cellulose square, with (ii) the results of Reticulitermes tibialis feeding on samples of cellulose feeding squares having various levels of sitosterol included.

FIG. 3 is a bar graph illustrating the percent (by area) of a paper bait matrix eaten by termites, wherein each pair of touching bars represent the percentage of a corresponding bait matrix eaten by 100 termites, wherein the “sitosterol” shaded bar represents one side of each matrix that has had a solution of sitosterol applied thereto, and the “control” shaded bar represents the other side of the bait matrix having no sitosterol applied thereto.

FIG. 4 is a bar graph that compares: (i) the results of Coptotermes formosanus feeding on a “control” cellulose feeding square provided on a thin-layer chromatography (TLC) glass plate, wherein no sitosterol was provided to the control cellulose square, with (ii) the results of Coptotermes formosanus feeding on samples of cellulose feeding squares having various levels of sitosterol provided thereon.

### DETAILED DESCRIPTION

The present invention is generally directed to using sitosterol or mimics thereof as a feeding stimulant for each of the subterranean termite species: Coptotermes formosanus, Reticulitermes tibialis, Reticulitermes flavipes, and Reticulitermes virginicus. To demonstrate the efficacy of the present invention, the following description of various termite feeding assays are provided.

Aspen wood has been documented as a preferred wood by termites (Myles, T. 1994. Forest Products Journal 44: 33-36). Aspen wood (Populus tremuloides) was purchased from a local lumber yard (Sears Trostel, Fort Collins, Colo.). The aspen wood was cut into shavings with a drill press (Delta 16.5@ Drill Press) and extracted briefly with hexane (1 gram, 10 minutes). Trimethylsilyl (TMS) derivatives of the compounds in the resulting hexane extract were prepared with bis(trimethylsilyl)trifluoroacetamide (BSTFA), and 1% trimethylchlorosilane by heating at 65° C. for 30 minutes. Gas chromatography-mass spectrometric analysis was conducted on the derived TMS preparation with a Hewlett-Packard II 5890 GC and 5971 mass selective detector. Sitosterol was chemically identified from the aspen wood extract (more particularly, the TMS preparation) on the basis of its mass spectrum. Moreover, to further substantiate that sitosterol had been identified, an authentic sample of sitosterol (from Sigma Chemical Company, St. Louis, Mo. 63178) was also derivatized with BSTFA, and compared with the sitosterol TMS preparation. Both had an identical mass spectrum and gas chromatographic retention time. Thus, this at least provides evidence that sitosterol appears to not repel termites at the low doses found in Aspen wood (e.g., 0.2% to 2%, and more particularly, approximately 0.745%).

Field Tests

Sitosterol was tested in the field as a feeding stimulant for Reticulitermes tibialis. Sitosterol (300 mg) was dissolved in 30 ml of acetone and added to 30 gm of cellulose powder (from Bio-Serv Inc., Frenchtown, N.J.), and the combination was dried overnight. A hydraulic press (providing 15,000 pounds per square inch force) was used to make hard pellets (wherein each pellet was approximately 3 gm, 2.5 cm diameter, 5 mm thickness, having 1% sitosterol and 99% cellulose). Control pellets of cellulose powder alone (3 gm) were made similarly.

The pellets were tested in underground termite traps made from Nalgene jars (having dimensions of approximately 10 cm diameter, 10 cm height) with 3 mm holes drilled at 3 cm intervals to allow termites to enter each jar. The jar traps were filled with soil (20% moisture). Two pellets were placed on the surface of the soil both within and at the top of each jar trap, one pellet containing cellulose (3 gm) plus sitosterol (300 mg) and the other pellet containing only cellulose (3 gm).

One of the jar traps containing a 1% sitosterol pellet and a cellulose control pellet was placed at the base of a fence post that was previously determined to be infested with termites. The traps were checked once a week for feeding. When termite feeding was apparent, both pellets were removed and weighed to determine the amount of each pellet that had been eaten. A total of 15 of the above prepared jar traps were tested in the field in this manner. For the 15 jars tested, FIG. 1 shows the average weight of each of the two types of pellets eaten by the termites. Thus, the termites ate substantially more of the sitosterol containing pellets (i.e., more than twice as much).

Cellulose TLC Plate Feeding Bioassay

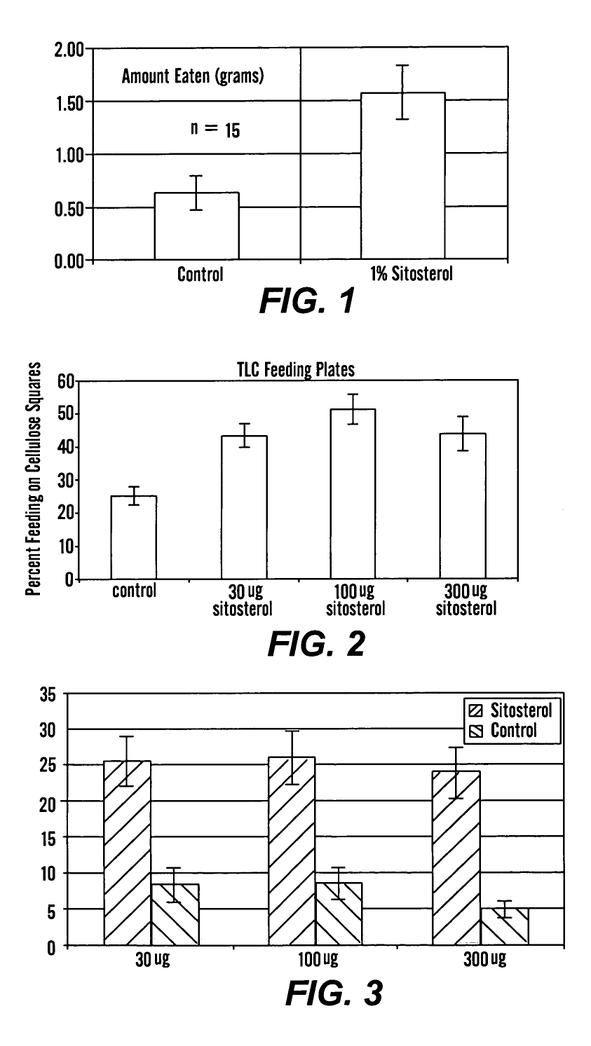

The present inventors show in FIG. 2, the results of laboratory behavioral bioassays wherein Reticulitermes tibialis fed significantly more on cellulose that was treated with sitosterol, and importantly, this termite species fed significantly more on cellulose for every sitosterol dose tested (i.e., 30 micro-grams (ugm), 100 ugm, and 300 ugm). Such behavioral feeding bioassays were conducted using the following protocol.

Termite workers (100 total) were removed from their storage tubs and placed in a smaller plastic Rubbermaid® tub (having a volume of 414 ml) that contained soil (with a 20% by weight moisture). These termites were allowed to acclimate to their new surroundings for 24 hours before the feeding bioassay began. Solutions of sitosterol in acetone (of 1.0 ugm/ul, 3.0 ugm/ul, or 10 ugm/ul, respectively) were applied to three different cellulose squares with a Hamilton syringe (of 100 micro-liters (ul) capacity), wherein the squares were provided on a single thin-layer chromatography (TLC) glass plate. For the three cellulose squares, each single cellulose square (of 13.43 mg of cellulose) was evenly wetted with 30 ul of only one of the solutions. Thus, a dose of one of 30 ugm, 100 ugm or 300 ugm of sitosterol was applied, respectively, to a corresponding one of the cellulose squares. Accordingly, the concentrations on these three cellulose squares were, respectively, 2.23 ugm sitosterol/mg cellulose (equivalently, 0.2223% sitosterol to cellulose), 7.45 ugm sitosterol/milligram (mg) cellulose (equivalently, 0.745% sitosterol to cellulose), and 22.34 ugm sitosterol/mg cellulose (equivalently, 2.23% sitosterol to cellulose). Note that a fourth cellulose square was treated with 30 ul of acetone as a control. Further note that the cellulose squares were chosen at random for the application of one of the sitosterol solutions, and the cellulose squares were allowed to dry for 24 hours before testing. The bioassay began when the TLC plate containing each of these three “experimental” squares and the additional control square (having no solution of sitosterol thereon) was placed into the plastic tub containing the 100 termites. The TLC plate in the tub was checked daily for 7 days and removed. If the termites had completely consumed any one of the four squares before 7 days, the TLC plate was removed as soon as this condition was observed. A scanned image of each square was used to determine the amount of cellulose eaten by the termites for each particular square (using a Hewlett-Packard Office Jet R80 and Adobe Photoshop7 5.5 using the “Histogram” command to count pixels). This experiment was replicated 36 times for each dose.

Accordingly, from the results of FIG. 2, it is believed that Reticulitermes tibialis can be induced to feed more at even lower doses of sitosterol, e.g., 0.1% sitosterol to cellulose (or other termite edible material).

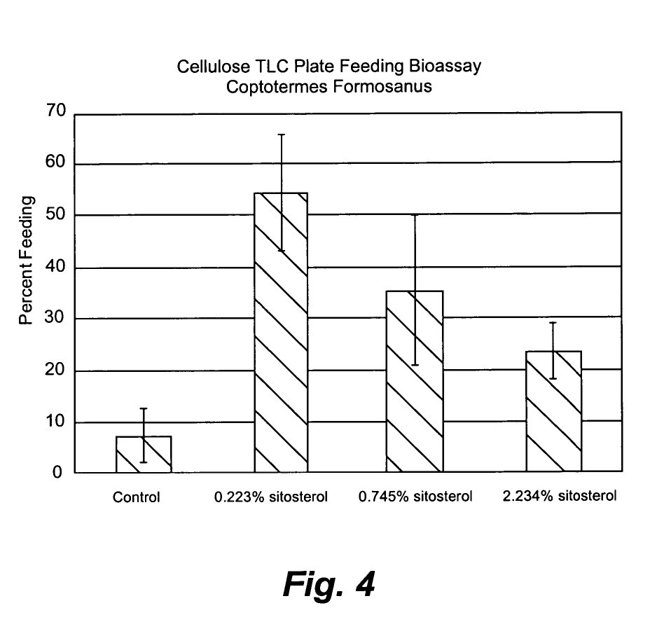

FIG. 4 shows similar laboratory behavioral bioassay results for Coptotermes formosanus wherein a similar protocol to that above was performed. The concentrations of sitosterol provided on the three “experimental” squares for the present bioassay were the same as those in the bioassay for the Reticulitermes tibialis termites described above, i.e., 2.23 ugm sitosterol/mg cellulose (equivalently, 0.2223% sitosterol to cellulose), 7.45 ugm sitosterol/mg cellulose (equivalently, 0.745% sitosterol to cellulose), and 22.34 ugm sitosterol/mg cellulose (equivalently, 2.23% sitosterol to cellulose), respectively. As clearly shown in FIG. 4, Coptotermes formosanus ate substantially more of the squares having sitosterol thereon.

Accordingly, from the results of FIG. 4, it is believed that Coptotermes formosanus can be induced to feed more at even lower doses of sitosterol, e.g., 0.1% by weight of sitosterol to cellulose (or other termite edible material).

Moreover, it is believed that the results from the above described bioassays are representative of termite behavior that would occur in a termite trap. Thus, by adding sitosterol to a termite trap so that the sitosterol is provided on or mixed with a termite edible material, and wherein the concentration of sitosterol by weight to termite edible material is at least one of: 0.1%, and 0.2223%, it is believed that termites will consume more of the edible material than without the sitosterol. Moreover, it is believed that adding sitosterol to a composition of a termite edible material and insecticide may diminish the termites aversion to feeding on this composition.

Paper Feeding Bioassay

FIG. 3 shows the results of a second collection of tests where 100 termite workers (of species Reticulitermes tibialis) were removed from their storage tubs and placed in a smaller plastic tub (Rubbermaid®, having a volume of 414 ml) that contained soil (having 20% moisture by weight). The termites in the tub were allowed to acclimate to their new surroundings for 24 hours before the present feeding bioassay began. Each of three rectangular bait matrixes (each matrix being approximately 100 mg of bait substrate, the substrate being paper) was divided in two halves with a pencil line, each half having a 50.06 mg bait substrate upon which the termites were to feed. For each bait matrix, one half (the “experimental” half) was provided with a given sitosterol dose, and the other half was provided as a control, and accordingly had no sitosterol applied thereto. In particular, for each bait matrix, exactly one of three solutions of sitosterol in acetone (each solution having one of the concentrations: 1 ugm/ul, 3 ugm/ul, or 10 ugm/ul) was applied to the “experimental” half of the bait matrix with a Hamilton syringe (of 100 ul capacity), and only acetone was applied to the other (control) half as a control. More precisely, the experimental half of each bait matrix rectangle was evenly wetted with 30 ul of a different one of the solutions of sitosterol, thus applying on the experimental bait matrix half of each bait matrix a dose of only one of 30 ugm, 100 ugm or 300 ugm of sitosterol. The sitosterol concentrations tested were therefore 0.60, 2.00, and 5.99 ugm sitosterol/mg of bait substrate. Note that placement of these solutions on a half (left or right) of each bait matrix was random.

After application of the solutions, each bait matrix was subsequently allowed to dry for 24 hours before testing. Each bioassay began when exactly one of the bait matrixes was placed into the tub containing the 100 termites. Note that for each of the three bait matrixes, a fresh set of 100 termites was introduced into the tub to feed only on this bait matrix. FIG. 3 shows the results of termite feeding for each of the three bait matrixes; i.e., each pair of touching bars show the termite feeding percentage for a different one of bait matrixes, wherein each bar identified by the “sitosterol” shading represents the percentage of the “experimental” half eaten by the termites, and each bar identified by the “control” shading represents the percentage of other (i.e., control) half eaten by the termites. Accordingly, as the results of FIG. 3 show, the area of the half of each bait matrix having a sitosterol solution applied thereto was consumed substantially more than the control side.

The present invention is therefore useful in several different applications relating to termite pest management. Without being all inclusive, the present invention is directed to the following:
(A) The use of any biological or chemical source of sitosterol for increasing feeding or inducing phagostimulatory responses by the termite species: Coptotermes formosanus, Reticulitermes tibialis, Reticulitermes flavipes, and/or Reticulitermes virginicus, or any other species in the genus Reticulitermes or any other species of termites.
(B) The use of any chemical mimics of sitosterol for increasing Coptotermes formosanus, Reticulitermes tibialis, Reticulitermes flavipes, and/or Reticulitermes virginicus feeding or inducing phagostimulatory responses.
(C) Behavioral manipulation of Coptotermes formosanus, Reticulitermes tibialis, Reticulitermes flavipes, and/or Reticulitermes virginicus, including but not limited to the following:
   a. Use of sitosterol or sitosterol mimics to increase feeding of Coptotermes formosanus, Reticulitermes tibialis, Reticulitermes flavipes, and/or Reticulitermes virginicus on baits and/or substances used to detect the presence of Coptotermes formosanus, Reticulitermes tibialis, Reticulitermes flavipes, and/or Reticulitermes virginicus, wherein such baits include: paper, cardboard, or any other materials containing cellulose.
   b. Use of sitosterol or sitosterol mimics to increase feeding of Coptotermes formosanus, Reticulitermes tibialis, Reticulitermes flavipes, and/or Reticulitermes virginicus on an insecticide, and in particular, the insecticides identified in the summary section hereinabove.
   c. Use of sitosterol or sitosterol mimics to affect the feeding behavior of Coptotermes formosanus, Reticulitermes tibialis, Reticulitermes flavipes, and/or Reticulitermes virginicus; e.g., providing a path of sitosterol laced baits to a termite trap so that the traps are discovered more quickly by the termites, or leading one termite species or colony to come in conflict with another termite species or colony.
   d. Use of sitosterol or sitosterol mimics as co-feeding stimulants for Coptotermes formosanus, Reticulitermes tibialis, Reticulitermes flavipes, and/or Reticulitermes virginicus along with other materials that may have fundamentally different chemistry. Such other materials may include sugars, carbohydrates, amino acids, lipids, proteins, or salts.
   e. Use of various methods, materials, devices for performing the function of the present invention, as set forth herein, or as one skilled in the art might develop, such as:
      (i) preparation and/or application of sitosterol laced termite baits (e.g., having a sitosterol concentration in the range of approximately 0.01% by weight to approximately 6% by weight),
      (ii) combining and/or applying sitosterol in combination with an insecticide for exterminating termites,
      (iii) preparation and/or application of substances having concentrations of sitosterol that are greater than the concentrations that naturally occur in wood (e.g., Aspen wood), wherein such greater concentrations are in the range of 0.2% to 2%, and/or
      (iv) combining and/or applying sitosterol (or formulation thereof) in combination with other substances for attracting termites and/or further enhancing termite feeding, and in particular, combining and/or applying sitosterol with a material(s) or apparatus for generating carbon dioxide (or a mimic thereof), wherein the CO₂ generating material or apparatus generates CO₂ in the concentration range of approximately at least 0.2% by volume of an ambient atmosphere about the sitosterol (or formulation having sitosterol), wherein this CO₂ concentration extents beyond the sitosterol (or formulation having sitosterol) an effective distance for attracting termites to the sitosterol (or formulation having sitosterol). Note that it has been shown that a CO₂ concentration in the range of approximately at least 0.2% by volume is attractive to termites (of course such range does not extend up to a level that causes termite inactivity or death, e.g., a CO₂ concentration of 20%). Further disclosure of termite attraction to CO₂ concentrations is disclosed in co-pending U.S. patent application Ser. No. 09/831,094, filed Nov. 21, 2001, fully incorporated herein by reference. In particular, the CO₂ generating material(s) or apparatus may include charred materials, spent brewer's grain, ground germinated corn seeds and/or a bicarbonate formulation. Other termite feeding stimulants (reported by several researchers) can also be used in conjunction with the present sitosterol formulations, including those mentioned in the following references:
         (1) D-aspartic acid and L-glutamic acid were fed upon more than a water control by Coptotermes formosanus Shiraki. Chen, J., and G. Henderson (1996) J. Chem. Ecol. 22: 2359-2369, fully incorporated herein by reference.
         (2) Hydroquinone, a termite labial gland secretion, stimulated feeding in Mastotermes darviniensis and Coptotermes lacteus), as disclosed in PCT patent WO 00/36914 (29 Jun. 2000) fully incorporated herein by reference.
         (3) An ergosterol-containing bait matrix was fed upon preferentially by Coptotermes formosanus in a two-choice test with southern yellow pine. Rojas, G., and J. Morales-Ramos (2001) J. Econ. Entomol. 94:506-510

Note that the disadvantages of using the termite attractants of (iv)(1) through (vi)(3) described above alone, is as follows:
1. D-aspartic acid has shown toxicity to termites in extended feeding tests (e.g., of greater than 30 days). If termites are killed before they can spread a toxicant throughout the colony, a decrease in baiting efficacy could result.

2. The phagostimulatory effects of hydroquinone lasted only one month due to the volatility of this compound.

Note that Chitin synthesis inhibitors, such as hexaflumuron, were added to the bait matrix described in the bioassays above resulting in less feeding on the bait matrix treated with hexaflumuron compared to its control. This suggests a possible feeding deterrent effect when this bait had a pesticide added to it. Accordingly, it is believed that adding sitosterol to such a bait matrix may provide a way to overcome the termites' aversion to hexaflumuron.

The component parts or steps of the present invention include:
The use of any chemical source of sitosterol at any concentration to increase or manipulate Coptotermes formosanus, Reticulitermes tibialis, Reticulitermes flavipes, and Reticulitermes virginicus feeding.
The use of any biological source of sitosterol at any concentration to increase or manipulate Coptotermes formosanus, Reticulitermes tibialis, Reticulitermes flavipes, and Reticulitermes virgin icus feeding.
The use of any chemical mimics of sitosterol at any concentration to increase or manipulate Coptotermes formosanus, Reticulitermes tibialis, Reticulitermes flavipes, and Reticulitermes virginicus feeding.

Several aspects of sitosterol make it a promising compound for enhancing Coptotermes formosanus, and Reticulitermes tibialis control. Sitosterol is a stable, nonvolatile compound which has shown no toxic effects to termites. Termite baits are most frequently placed in the soil where moisture conditions are a factor; i.e., soil having at least 20% moisture, and/or occasionally saturated with water. Sitosterol is a hydrophobic compound which resists being washed off by soil moisture/water. Sitosterol has little toxic risk, and it has been tested in humans as an alternative method to lower plasma cholesterol levels. Sitosterol is an economically rational additive to a termite bait system. For example, the cost of the sitosterol needed to treat one termite bait roll of the size and proportion of paper (e.g., 10 cm by 100 cm) is about one cent to reach the concentration of our highest tested dose (300 ugm).

The present invention is further directed to the use of a particular plant sterol or stanol for increasing termite feeding, wherein such material is selected from the group consisting of beta-sitosterol, alpha-sitosterol and gamma-sitosterol, or a combination thereof, and including any mimics of such chemicals which have similar chemical functionality and/or structure.

Also incorporated herein in its entirety is pending U.S. patent application Ser. No. 09/573,795 filed May 16, 2000 by BERNKLAU et al. Moreover, to supplement the written description provided herein, the following issued United States patents are incorporated herein by this reference in their entireties, such references providing additional information with respect to the manufacture of compounds, in particular sitosterol, useful in the present invention: U.S. Pat. No. 6,162,483 filed Apr. 22, 1998 by Wester; U.S. Pat. No. 4,265,824 filed Dec. 5, 1979 by Koskenniska, et al.; U.S. Pat. No. 3,879,431 filed Oct. 5, 1993 by Clark et. al.; U.S. Pat. No. 6,136,349 filed Jun. 29, 1998 by Karppanen, et al.; and U.S. Pat. No. 6,068,867 filed Jul. 14, 1997 by Nussinovitch, et al.

While various embodiments of the present invention have been described in detail, it will be apparent that further modifications and adaptations of the invention will occur to those skilled in the art. It is to be expressly understood that such modifications and adaptations are within the spirit and scope of the present invention.

1. A method for increasing the intake of food by termites of the genus and species of any one of: Coptotermes formosanus, Reticulitermes tibialis, Reticulitermes flavipes, and Reticulitermes virginicus.comprising:
providing a first composition including sitosterol or a mimic thereof;
providing a second composition including a food for the termites;
combining a first composition to the second composition thereby obtaining a resulting formulation;
wherein at least one of: (i) the concentration of sitosterol in the first composition is at least approximately 1.0 gm/liter, and (ii) the resulting formulation has a concentration of at least approximately 0.22% of sitosterol to a termite edible one or more substances in the resulting formulation; and
wherein when the resulting formulation is accessed by the termites, an effective increase in feeding of the termites occurs over that of the second composition.

2. The method of claim 1, wherein said formulation includes approximately 1% of sitosterol.

3. The method of claim 1, wherein said formulation includes approximately 2.23 ugm sitosterol/mg of cellulose.

4. The method of claim 1, wherein said formulation is provided in a termite trap.

5. The method of claim 1, further including a step of providing said formulation together with a substance that is toxic to termites.

6. The method of claim 5, wherein said toxic substance includes one or more of: noviflumuron, sulfluramid, hydramethylnon, diflubenzuron, fipronil, imidacloprid, boric acid, cypermethrin, permethrin, bifenthrin, esfenvalerate, deltamethrin, cyfluthrin, silica gel, propoxur, hexaflumuron, a chitin synthesis inhibitor, a substance that prevents molting, lufenuron, thiamethoxam, a pesticide from the neo-nicotinoid family of pesticides.

7. The method of claim 1, further including a step of providing said formulation together with a CO₂ generating material or apparatus, wherein the CO₂ generating material or apparatus generates carbon dioxide or a mimic thereof in the range of approximately at least 0.2% by volume of an ambient atmosphere.

8. The method of claim 7, wherein the CO₂ generating material or apparatus includes one or more of: a charred material, spent brewer's grain, ground germinated corn seeds and/or a bicarbonate formulation.

9. A termite trap comprising an enclosure containing a concentration of sitosterol, wherein said concentration is effective for inducing an enhanced phagostimulatory response in a termite over a termite feeding source having less than a 0.1% concentration of sitosterol, or substantially no concentration of sitosterol.

10. The termite trap of claim 9, wherein said concentration is approximately 1% of sitosterol.

11. The termite trap of claim 9, wherein the concentration of sitosterol to a termite edible material is at least approximately 0.1%.

12. The termite trap of claim 9, wherein the concentration of sitosterol to a termite edible material is at least approximately 0.2%.

13. The termite trap of claim 9, wherein said concentration is approximately at least 0.60 ugm sitosterol/mg of a termite bait.

14. The termite trap of claim 9, wherein said concentration included in a pellet.

15. The termite trap of claim 9, wherein said concentration is provided on a termite as a liquid.

16. The termite trap of claim 9 further including soil therein.

17. The termite trap of claim 9 further including a substance that is toxic to termites.

18. The termite trap of claim 17, wherein said toxic substance includes one or more of: noviflumuron, sulfluramid, hydramethylnon, diflubenzuron, fipronil, imidacloprid, boric acid, cypermethrin, permethrin, bifenthrin, esfenvalerate, deltamethrin, cyfluthrin, silica gel, propoxur, hexaflumuron, a chitin synthesis inhibitor, a substance that prevents molting, lufenuron, thiamethoxam, a pesticide from the neo-nicotinoid family of pesticides.

19. The termite trap of claim 9, further including a CO₂ generating material or apparatus, wherein the CO₂ generating material or apparatus generates carbon dioxide or a mimic thereof in the range of approximately at least 0.2% by volume of an ambient atmosphere.

20. The method of claim 19 wherein the CO₂ generating material or apparatus includes one or more of: a charred material, spent brewer's grain, ground germinated corn seeds and/or a bicarbonate formulation.

21. A method for increasing the intake of food by a termite, wherein sitosterol or a mimic thereof is present in an amount of at least 300 micrograms in a formulation at a termite trap.

22. The method of claim 21, wherein said formulation includes approximately 1% of sitosterol.

23. The method of claim 21, wherein said formulation includes at least one of: beta-sitosterol, alpha-sitosterol and gamma-sitosterol.

24. The method of claim 21, wherein said formulation includes one of: D-aspartic acid, L-glutamic acid, hydroquinone, and ergosterol.

25. The method of claim 21, wherein said formulation includes one or more of the following substances toxic to termites: noviflumuron, sulfluramid, hydramethylnon, diflubenzuron, fipronil, imidacloprid, boric acid, cypermethrin, permethrin, bifenthrin, esfenvalerate, deltamethrin, cyfluthrin, silica gel, propoxur, hexaflumuron, a chitin synthesis inhibitor, a substance that prevents molting, lufenuron, thiamethoxam, a pesticide from the neo-nicotinoid family of pesticides.

26. A formulation for use at termite traps comprising an effective amount of sitosterol, or mimics thereof, to increase a feeding habit of termites of Coptotermes formosanus, or Reticulitermes tibialis at said trap as compared to feeding habits thereof when feeding on other than said formulation, wherein said effective amount of sitosterol is provided with a substance toxic to the termites.

27. The formulation of claim 26, wherein the formulation includes at least 0.01% by weight of sitosterol, or mimics thereof.

28. A method for increasing the intake of food by termites, comprising:
providing a first composition including sitosterol or a mimic thereof;
providing a second composition including a food for the termites;
combining a first composition to the second composition thereby obtaining a resulting formulation;
wherein at least one of: (i) the concentration of sitosterol in the first composition is at least approximately 1.0 gm/liter, and (ii) the resulting formulation has a concentration of at least approximately 0.01% of sitosterol to a termite edible one or more substances in the resulting formulation; and
wherein when the resulting formulation is accessed by the termites, an effective increase in feeding of the termites occurs over that of the second composition.

29. The method of claim 28, wherein said formulation includes approximately 1% of sitosterol.

30. The method of claim 21, wherein the termite is from one of the genus and species: Reticulitermes tibialis, Reticulitermes flavipes, and Reticulitermes virginicus.

31. The method of claim 21, wherein the termite is of the genus and species Coptotermes formosanus.

32. The method of claim 28, wherein the termites are from one of the genus and species: Reticulitermes hesperus, Reticulitermes hageni, and Heterotermes species.

33. The method of claim 28, wherein said formulation includes approximately 1% of sitosterol.

34. The method of claim 28, wherein said formulation includes approximately 2.23 ugm sitosterol/mg of cellulose.

35. The method of claim 28, wherein said formulation is provided in a termite trap.

36. The method of claim 28, further including a step of providing said formulation together with a substance that is toxic to termites.

37. The method of claim 36, wherein said toxic substance includes one or more of: noviflumuron, sulfluramid, hydramethylnon, diflubenzuron, fipronil, imidacloprid, boric acid, cypermethrin, permethrin, bifenthrin, esfenvalerate, deltamethrin, cyfluthrin, silica gel, propoxur, hexaflumuron, a chitin synthesis inhibitor, a substance that prevents molting, lufenuron, thiamethoxam, a pesticide from the neo-nicotinoid family of pesticides.

38. The method of claim 28, further including a step of providing said formulation together with a CO₂ generating material or apparatus, wherein the CO₂ generating material or apparatus generates carbon dioxide or a mimic thereof in the range of approximately at least 0.2% by volume of an ambient atmosphere.

39. The method of claim 38, wherein the CO₂ generating material or apparatus includes one or more of: a charred material, spent brewer's grain, ground germinated corn seeds and/or a bicarbonate formulation.
